(19) United States
(12) Patent Application Publication
(10) Pub. No.: US 2016/0380766 A1
(43) Pub. Date: Dec. 29, 2016

(54) ENCRYPTION SYSTEM WITH A GENERATOR OF ONE-TIME KEYS AND A METHOD FOR GENERATING ONE TIME-KEYS

(71) Applicant: Adips Spolka z ograniczona odpowiedzialnoscia, Zielona Gora (PL)

(72) Inventors: Janusz JABLONSKI, Zielona Gora (PL); Michal WENDROWSKI, Zielona Gora (PL); Witold WENDROWSKI, Zielona Gora (PL)

(21) Appl. No.: 14/979,588

(22) Filed: Dec. 28, 2015

(30) Foreign Application Priority Data
Jun. 29, 2015 (PL) PL412893

(51) Int. Cl. H04L 9/08

(52) U.S. Cl. CPC H04L 9/0861

(57) ABSTRACT

A computer-implemented method for irreversible generating of distinct one-time encryption keys. For each subsequent operation of generating the one-time encryption key, the method comprises the following steps, performed with a one-time key generator: reading previously stored values P and Q to obtain read values P and Q, wherein the values P and Q are probable prime numbers; modifying the read values P and Q by using a modifier M and an additive operation, including size adjustment to obtain modified values P and Q; generating, based on the modified values P and Q, new values P and Q as probable prime numbers; storing the new values P and Q as stored values P and Q; executing a multiplication operation on the stored values P and Q to determine a new value N; and providing the new value N as a new component of the one-time encryption key.

### BACKGROUND

This disclosure is related to an encryption system for generating one-time keys.

Cryptographic systems that utilize one-time keys provide high security level to systems for data processing, transmission and sharing. One-time keys are encryption keys that are changed at each encryption operation. The use of one-time keys significantly enhances effectiveness and security level of cryptographic systems, providing immunity to statistical and differential cryptoanalysis, as well as to attacks based on analysis of encrypted fake messages. Moreover, one-time keys allow a high level of security of a cryptographic system for a one-time key of a smaller size compared to a standard cryptographic many-time key. This results in lower requirements for resources to handle the encryption system, including electronic circuits, energy consumption and encryption time.

There are known numerous prior art cryptographic systems using one-time keys.

A polish patent PL218339 discloses an encryption module using one-time keys that operates according to the RSA encryption scheme and comprises: an encryption module with a programmable circuit, a transaction intermediary circuit storing data regarding configuration of the encryption module, and a transaction server generating a data stream that describes a difference between subsequent configurations of the encryption circuit. Upon reception of a data stream from the transaction intermediary circuit, the encryption system extracts data responsible for adapting the encryption module to a subsequent encryption operation. For a given transaction, which is equivalent to generation of an encrypted message, it is necessary to transmit, to the encryption module, data that allows configuring its encryption circuit to a new value of the encryption key. That system comprises three communicating subsystems: the encryption subsystem, the transaction intermediary and the transaction server. Information for the reconfigurable circuit is transmitted between these subsystems to generate a next encrypted message. A three-way communication of the transaction server with the transaction intermediary and finally with the encryption circuit, preceding the encryption operation, is prone to recreating the secret encryption key in an unauthorized manner. The unauthorized action can be done provided the unauthorized entity has access to a copy of the encryption circuit and current information on a key, comprised in the data stream describing the next configuration of the encryption circuit. Although copying the encryption circuit and sniffing configuration data for the encryption circuit is not easy, it is nevertheless possible. Moreover, the disclosure of PL218339 does present details on how to generate the one-time keys.

A US patent application US20140369498 discloses a system that also uses a three-way communication before the encryption operation using a one-time key is finished. The three subsystems communicate using a computer network in order to exchange data necessary for generating and distributing the one-time keys. A one-time keys center uses a random numbers generator to generate values having the size of 8 bits, which are subsequently used to create a multi-component encryption key having the number of components adapted to the size of the encrypted message. To breach the security of that cryptographic system, the encryption keys may be obtained by sniffing the transmission of the key or copying the random numbers generator.

A US patent application US20150016606 discloses a cryptographic system that uses a pseudorandom sequences generator. The system transmits information on the encryption key before the encryption. A number forming a key sequence of a server is used during generating keys for system users. The keys for users are generated by combining the values retrieved from the preceding key value of the user key—as a fixed component of the key, and a section of the current key sequence of the server—as a variable component of the key. This solution also requires communication that precedes the encryption. Therefore, there is a risk of unauthorized acquisition of the key sequence of the server or a risk of sniffing the communication related to the update of the user key. Therefore, the redundant communication and use of the pseudorandom generator are prone to unauthorized replication of the generated server keys and allow replication of user keys, which may lead to breach of security of the cryptographic system.

Therefore, in the aforementioned prior art cryptographic solutions based on one-time keys, there is a problem in secure acquisition and negotiation of keys that are changed for each encryption operation.

The prior art solutions related to negotiating on one-time keys involve sharing of the keys used to encrypt messages before the communication, or involve ad-hoc generating of the keys for each data exchange. This exchange of information regarding the currently used key (preceding the encryption), which is realized by means of computer or telecommunication networks, is prone to unauthorized sniffing of information and therefore results in a decrease of security level of the system.

Another method for generation of keys, which is also risky, involves the use of pseudorandom number generators that generate values that are prone to copying and/or guessing, in particular when these are used for generating one-time keys. The keys can be provided in form of scratch-off cards or other kind of communication of a predefined set of values (from which components of encryption keys can be selected), but these are subject to being lost, copied or replicated by unauthorized persons. Moreover, for these solutions it is difficult to determine how many one-time keys will be required by a user in a given time period, e.g. the following 1 month. Another method for providing one-time keys involves ad-hoc notifications, e.g. via telephone SMS (Short Message System) messages, but it is not secure due to the possibility of sniffing the messages as well as not convenient to use, due to the necessity of manual copying of the keys by the user.

The disadvantages discussed above could be overcome by a cryptographic system that does not require exchange of information about the one-time key before the encryption. These disadvantages could be also overcome by a cryptographic system that does not generate one-time encryption keys using pseudorandom sequences, that are naturally based on algorithmic, reversible properties of repetitive physical properties. Such system could be immune to the copying of the pseudorandom generator and therefore to unauthorized generation of keys.

Therefore, there is a need to provide a new encryption system comprising a circuit for generating one-time keys, as well as a method for generating one-time keys, which would address one or more of the aforementioned drawbacks of the known cryptographic systems.

### SUMMARY

In particular, there is disclosed a computer-implemented method for irreversible generating of distinct one-time encryption keys, wherein for each subsequent operation of generating the one-time encryption key, the method comprises the following steps, performed with a one-time key generator: reading previously stored values P and Q to obtain read values P and Q, wherein the values P and Q are probable prime numbers, wherein a new value P is generated by reading the value P or Q depending on a state of a signal v and wherein a new value Q is generated by reading the value P or Q depending on a state of a signal w, wherein the signals w and v are any two bits of a number N except the least and most significant bits of the number N, wherein N is a result of multiplication performed in a preceding operation of generating the one-time encryption key for the stored values P and Q; modifying the read values P and Q by using a modifier M and an additive operation, including size adjustment to obtain modified values P and Q; generating, based on the modified values P and Q, new values P and Q as probable prime numbers; storing the new values P and Q as stored values P and Q; executing a multiplication operation on the stored values P and Q to determine a new value N; and providing the new value N as a new component of the one-time encryption key.

Preferably, in the step of reading the stored P and Q values, for a subsequent generation of a new value P, the stored P or Q is read, depending on the state of a signal v, and for a subsequent generation of a new value Q, the stored P or Q is read, depending on the state of a signal w, wherein the signals w and v are any two bits of the number N except for the least and most significant bits of the number N, wherein N is the result of multiplication performed in the previous operation of generating the key based on stored values P and Q.

Preferably, an encrypted message S=W^{e} modulo N is generated for a message W and the one-time encryption key {e, N}, whereas e is a coprime integer from φ(N), wherein φ(N) is an Euler's function for N described with the following equation φ(N)=(P−1)(Q−1).

Another aspect presented herein is a computer program comprising program code means for performing all the steps of the computer-implemented method as presented herein when said program is run on a computer.

Yet another aspect presented herein is a computer readable medium storing computer-executable instructions performing all the steps of the computer-implemented method as presented herein when executed on a computer.

In particular, there is disclosed a circuit for generating one-time encryption keys, the circuit comprising the following elements. A first register having: a first input P for receiving a value P, a second input s for receiving a control signal s, the first register being configured to store the value P in response to the control signal s and to provide the value P at its output. A second register having: a first input Q for receiving a value Q, a second input s for receiving a control signal s, the second register being configured to store the value Q in response to the control signal s and to provide the value Q at its output. A first multiplexer having: a first input connected to the output of the second register, a second input connected to the output of the first register, and a third input connected to an output v of a multiplying circuit, the first multiplexer being configured to provide at its output the value Q or P depending on the state of a signal v at its third input. A second multiplexer having: a first input connected to the output of the first register, a second input connected to the output of the second register, and a third input connected to an output w of a multiplying circuit, the second multiplexer being configured to provide at its output the value P or Q depending on the state of a signal w at its third input. A first circuit for modification of input number values, having: a first input X for receiving a number value and connected to the output of the first multiplexer, a second input M for receiving a modifier value M, a third input k for receiving the signal w and connected to the output w of the multiplying circuit, the first circuit for modification of input number values being configured to modify the number value provided at the first input X on the basis of the modifier value M and the state of the signal w and to provide at its output a modified number value. A second circuit for modification of input number values, having: a first input X for receiving a number value and connected to the output of the second multiplexer, a second input M for receiving the modifier value M, a third input k for receiving the signal v and connected to the output v of the multiplying circuit, the second circuit for modification of input number values being configured to modify the number value provided at the first input X on the basis of the modifier value M and the state of the signal v and to provide at its output a modified number value. A first circuit for generating probable prime numbers, having: a input MX for receiving an input number and connected to the output of the first circuit for modification of input number values, a first output XPP for outputting a probable prime number and connected to the first input P of the first register and to the first input P of the multiplying circuit, a second output s, for outputting an indication whether the number provided at the first output XPP is probably prime, the second output s being connected to the second input s of first register. A second circuit for generating probable prime numbers, having: a input MX for receiving an input number and connected to the output of the second circuit for modification of input number values, a first output XPP for outputting a probable prime number and connected to the first input Q of the second register and to the second input Q of the multiplying circuit, a second output s, for outputting an indication whether the number provided at the first output XPP is probably prime, the second output s being connected to the second input s of second register. A multiplying circuit having: a first input P connected for receiving a number P and connected to the first output XPP of the first circuit for generating probable prime numbers, a second input Q for receiving a number Q and connected to the first output XPP of the second circuit for generating probable prime numbers, the multiplying circuit being configured to: provide at its first output N an n-bit product N, wherein N=P*Q, provide at its second output v any bit of the product N except for the least and most significant bits of the product N, wherein the second output v is connected to the third input of the first multiplexer; provide at its third output w any bit of the product N except for the least and most significant bits of the product N, wherein the second output w is connected to the third input of the second multiplexer; wherein the product N is a component of the one-time encryption key.

Preferably, the modifier value M changes in time and is a power of 2 such that M=2^{z}, wherein an exponent z changes according to the size of a message W to be encrypted with the one-time encryption key {e, N}.

There is also disclosed herein an encryption system comprising the circuit for generating one-time encryption keys as described above. The system further comprises a modular exponentiation circuit having: a first input connected to the first output N of the multiplying circuit of the circuit for generating one-time encryption keys, a second input connected to an output of an input circuit, a third input for receiving a natural number e being a component of the one-time encryption key {e, N}, and configured to provide at its output an encrypted message S. The input circuit is configured to adjust, transform and synchronize an input signal W to the second input of the modular exponentiation circuit, wherein the second input of the modular exponentiation circuit is a multi-position binary input having a size of log₂ N.

Preferably, the circuit for generating one-time encryption keys comprises an input, to which there is provided a modifier value.

### BRIEF INTRODUCTION TO THE DRAWINGS

Example embodiments of the method and system are described hereinafter with reference to the accompanying drawings, wherein:

FIG. 1 shows schematically an example of an encryption system;

FIG. 2 shows schematically an example of a generator of one-time keys;

FIG. 3 shows schematically a circuit for modifying a value of a number;

FIG. 4 shows schematically a circuit for determining a size of a number;

FIG. 5 shows schematically a circuit for generating a probable prime number;

FIG. 6 shows schematically a multiplying circuit;

FIG. 7 shows a diagram indicating actions for determining and storing the probable prime number P;

FIG. 8 shows a diagram indicating actions for determining and storing the probable prime number Q;

FIG. 9 shows a diagram of a method for generating one-time keys for encryption operations and a method for determining an encrypted message S.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities. Usually, these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like. Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

As used herein, the term “example” means serving as a non-limiting example, instance, or illustration. As used herein, the terms “for example” and “e.g.” introduce a list of one or more non-limiting examples, instances, or illustrations.

### DETAILED DESCRIPTION

The exemplary embodiments presented herein will be described with reference to drawings, on which the same elements and structures are denoted by the same identifiers.

It will be evident for a skilled person, that signals, denoted by lines on drawings, refer to single or multiple signal lines.

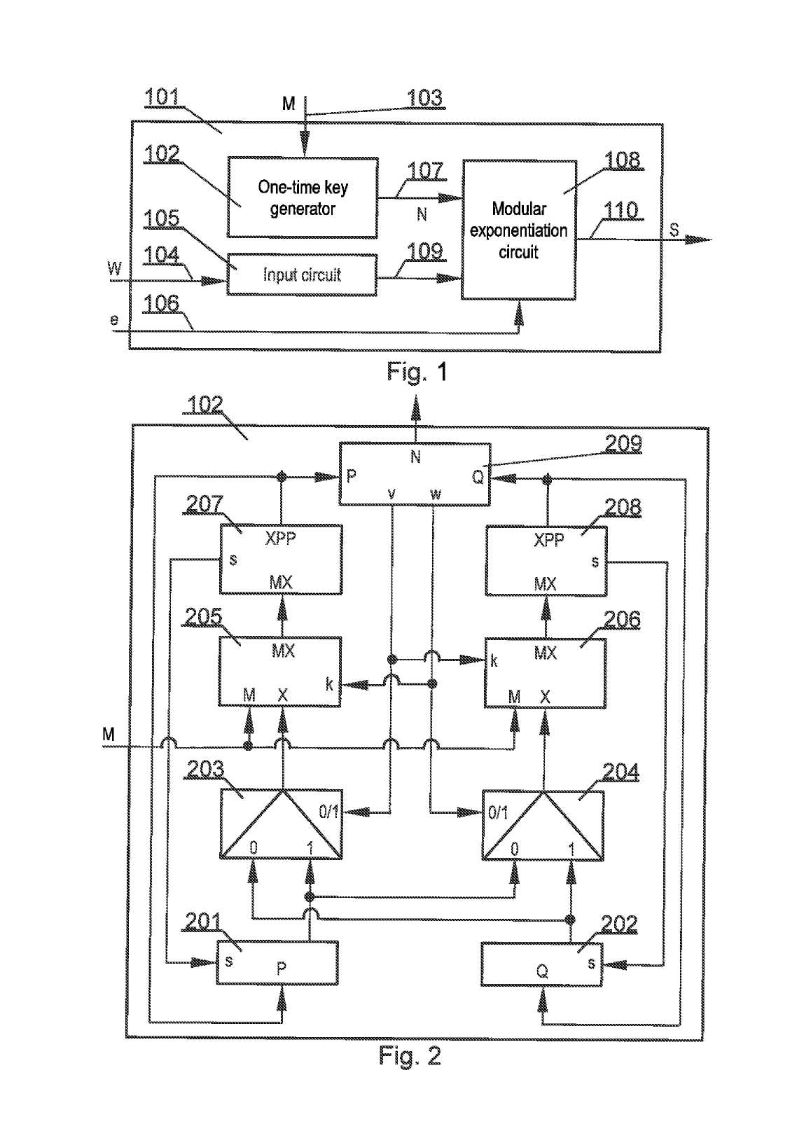

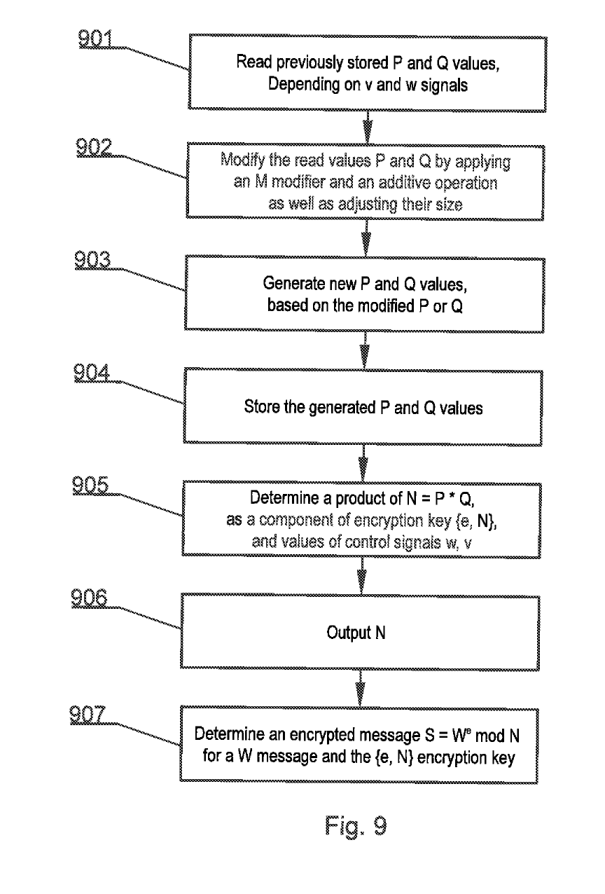

Preferably, the encryption system 101, shown as a block diagram in FIG. 1, generating an encrypted message S of a message W, comprises a circuit for generating one-time encryption keys 102 that receives, as an input parameter, a value M 103 and generates, as its output, a number N 107 that is a component of an encryption key. The Value M will be discussed with reference to FIG. 2, and the method for generating the encrypted message S will be discussed with reference to FIG. 9.

The output 107 of the circuit for generating one-time encryption keys 102, is connected to a first input of a modular exponentiation circuit 108, which also receives input data 109 from an input circuit 105. A third input 106 of the modular exponentiation circuit 108 receives a natural number e, which is a component of the encryption key {e, N}, wherein e is a natural number such that

GCD(e,φ(N))=1

wherein:
GCD is the greatest common divisor of e and φ(N);
N is a product of P*Q; and
φ(N) is the Euler's function for N defined by the following equation: φ(N)=(P−1)(Q−1).

For encrypting according to the RSA method, the encryption key {e, N} and the decryption key {d, N} are associated with the following relation:

e*d∝1moduloφ(N)

which guarantees the correctness of RSA, wherein the component d of the decryption key is defined with the following equation: d=e⁻¹ modulo φ(N).

The determination of the component d of the decryption key {d, N} is possible in an unambiguous manner only when GCD(e, φ(N))=1. Therefore, in order to execute the encryption or the decryption, it is necessary to know the two-component key for the encryption {e, N} or the decryption {d, N}, respectively. Moreover, for a constant e and variable N components, the component d of the decryption key also changes in relation to the value of φ(N).

The input circuit 105, depending on a type of the input bus (such as a USB, an I²C or a serial input interface), adjusts, transforms and synchronizes an input signal 104 with a multi-position binary input of the modular exponentiation circuit 108, having a size of log₂ N.

The aforementioned actions of adjusting and/or transformation are related, for example, to a change of a data stream communicated over a serial, one-bit data bus into a data stream for a multi-bit, parallel bus. The synchronization involves notifying an end of transformation and adjustment of voltage and/or current levels to values expected at the input of the subsequent circuit.

The modular exponentiation circuit 108 is known from the state of the art. In typical solutions, the modulo N exponentiation is typically executed for a constant value N, wherein in the present system the value of N is variable.

The encryption system 101 may be implemented by dedicated ASIC (Application Specific Integrated Circuit) components which are connected with microprocessor circuits or as a custom made FPGA (Field-Programmable Gate Array) system, or similar circuits.

Preferably, the circuit for generating one-time encryption keys 102, having a structure according to the block diagram shown in FIG. 2, comprises two register circuits 201, 202, two multiplexers 203, 204, two circuits for modification of input number values 205, 206, two circuits for generating probable prime numbers 207, 208 and a multiplying circuit 209.

In order to determine whether any natural number is a probable prime number, the most effective and most commonly used tests known in the prior art are probabilistic tests. They use randomly generated integers from a predefined range—a selection of these values can lead to an incorrect test result. However, if the number of the integers used is large enough, the probability of an incorrect result is low. If a sufficient number of trials fails to establish the compositeness of the natural number n, the test returns a response that n is a probable prime number.

The default values stored in the registers 201 and 202 are the numbers that determine the value of the component N of the encryption key, which is individual to a user, for which an encryption device is assigned (it determines the relationship between the user of the encryption system and the generator, such as e.g. a credit card having an initial value). If the power supply is switched off, in one embodiment, the registers 201 and 202 should preserve the last stored value, and not any value. After initializing the system (e.g. after a first start or a restart after an error), in one embodiment, the system cooperating with encryption system, executes a “safe mode” enabling to enter into the registers 201 and 202 the values determining the individual key N of the user. For example, these values can be the values provided to the user along with the device, determining the individual key N of the user.

Therefore, during the first use it is necessary to store P and Q in the registers 201 and 202. These values will be stored in the registers until they change to new values, created while generating a following key. Each of the registers 201 and 202 stores a value provided at its input in response to a control signal arriving from an output s of circuits for generating probable prime numbers 207, 208. The register 201, 202 provides the stored value at its output.

Each of the multiplexers 203, 204 comprises a first input “0” and a second input “1”. The states of these two inputs are provided to an output in response to the state of a control signal “0/1”.

Each of the circuits for modification of input number values 205, 206 comprises an input for receiving a given number value X, an input for receiving a modifier value M and a binary control input k for receiving a signal from respective outputs w or v of the multiplying circuit 209.

In another embodiment, each of the circuits for modification of input number values 205, 206 comprises a register for storing the value M, such that it is not necessary to have a separate input M.

Each of the circuits for generating probable prime numbers 207, 208 comprises an input for receiving an input number MX and an output for outputting a number XPP. Furthermore, the circuit for generating probable prime numbers 207, 208 comprises an output s for signalizing that the generated and output number XPP is a probable prime number.

The multiplying circuit 209 comprises inputs P and Q for receiving the terms of the product N, which is output on its output. Further, the multiplying circuit 209 comprises additional outputs of signals w and v.

For each initiated encryption operation, each of the circuits 207, 208 generates in parallel a probable prime number, P and Q, which form the terms of the product N=P*Q, which is a component of one-time encryption keys {e, N} and one-time decryption keys {d, E}.

In another embodiment, the circuit 209 may be notified about the fact that the numbers P and Q are probable prime numbers. Then, the multiplication is executed when both outputs s of the circuits 207 and 208 are set to “1”, indicating that both input numbers are probably prime.

Alternatively, both signals s may be output by the circuit 209. Alternatively, to an output of the circuit 102 in FIG. 2, there may be output a logical conjunction of the signals s from the circuits 207 and 208 in case a state of “1” indicates that the number XPP is probably prime.

In order to ensure different values of the encryption keys for consecutive encryption operations, the terms P and Q are generated based on numbers, which have been stored in the registers 201, 202 in the process of generating an encryption key for the previous encryption operation. At the same time, the inputs of circuits for generating probable prime numbers 207, 208 receive, each time, numbers different from those previously obtained, since the circuits for modification of input number values 205, 206 are connected to the multiplexers 203, 204 that select one of the two numbers P and Q stored in the previous encryption operation (the registers 201 and 202). These numbers are then modified in the operation of adding or subtracting the value of the modifier M.

Preferably, the modifier value M is a power of two, having the form of M=2^{z}, wherein the exponent z changes for different sizes of a message W to be encrypted with the one-time key {e, N}. The selection of the value of the modifier M guarantees that between P or Q and P+M or Q+M, respectively, there exists at least one probable prime number. This allows for effective generation, in the circuits 207, 208, of a probable prime number different from the value of P or Q, respectively. The value of the modifier M is determined based on a number π_{(X)}=X/InX, denoting the number of prime numbers not greater than X—it is one of the basic dependencies in number theory. Assuming that P and Q are 64-bit numbers, and that N=P*Q is a 128-bit number, the modifier M should have a value of 2¹⁴. Additionally, the changes of value of the modifier M allow adaptation of the value N to a size of the message W to be encrypted, so that N>W. Therefore, the size of N should be at least the size of the message W. If N has the size of 32 bits, and the size of the message W is 128 bits, then in order for the encrypted message S to also have the size of 128 bits, the modifier M should be of the size (128−32)/2=48 bits, i.e. it should have the value of 2⁴⁸. Then, preferably, M will be used in order to adjust P and Q and their product N to the size of the message W, as well as to the expected size of the encrypted message S.

Preferably, modifications by the modifier value M involve addition or subtraction, as an additive operation, with the value of P or Q, thereby increasing the number of probable prime numbers that can be generated in circuits 207, 208, based on the modified value MX. As a result, this increases the degree of unpredictability in generating of further components of the encryption keys N. Moreover, it is preferred because of the certainty of effective obtaining of a probable prime number.

As an effect of such actions, the inputs of the circuits for generating probable prime numbers 207, 208 receive each time the number P or Q, modified by being increased or decreased by the value M. As a result, each time there are stored and multiplied different numbers, which are generated as probable prime numbers.

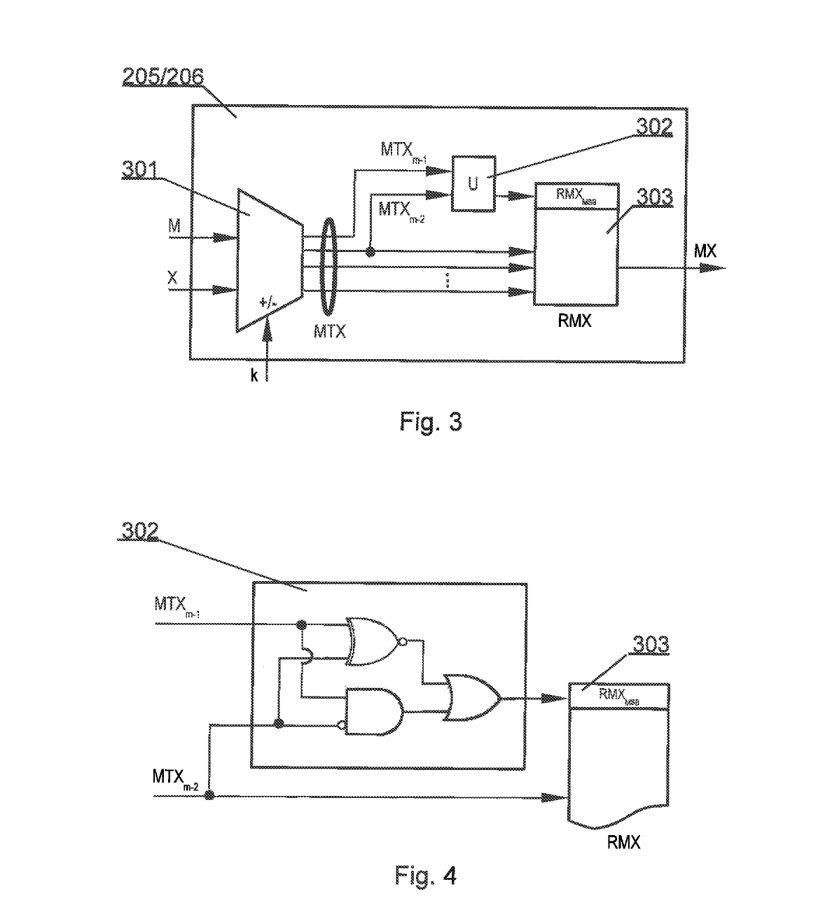

In a preferred embodiment, the circuits for modification of input number values 205, 206 as shown in FIG. 3, comprise an arithmetic unit 301 executing the additive operation—addition or subtraction, depending on the input value of a control signal k. A first logical level of the control signal k, for example “1”, results in that the arithmetic unit 301 executes an addition operation of the input numbers (X+M), while a second logical level of the control signal k, for example “0”, results in that the arithmetic unit 301 executes a subtraction operation of the input numbers (X−M).

The circuit for modification of input number values 205, 206 comprises a circuit 302 which may have a structure according to the block diagram shown in FIG. 4. This circuit 302 is responsible for determining the required bit size of the result MX obtained after executing the additive operation on the M and X numbers.

In the example shown in FIG. 3, the number MX is presented as a multi-bit number having distinguished two most significant bits MTXₘ₋₁ and MTXₘ₋₂. It will be evident for a skilled person, that the number of bits of the number MX equals to a half of the number of bits resulting from the bit size of the message W to be encrypted. The two most significant bits MTXₘ₋₁ and MTXₘ₋₂ of the number MX are distinguished to increase the clarity of description of the circuit U 302 for determining a required size of the number MX.

The aforementioned control is effected such that the circuit 302 sets a value of “1” on the most significant bit RMX_{MSB} of the value RMX, each time when on the two most significant bits MTXₘ₋₁ and MTXₘ₋₂ of the result MTX, of the additive operation execution on the numbers M and X, there are obtained logical levels of “0”. This control is achieved by appropriate connection of logical gates, as shown in FIG. 4. The bit RMX_{MSB} set to value “1” guarantees that the value MX will have a bit size of n expressed by the following equation n=log₂ N. Therefore, the number N will be within a preferred range of vales from 2″ⁿ⁻²+1 to 2ⁿ−1. In this manner there is controlled a size of numbers directed by the circuits for generating probable prime numbers 207, 208 to the multiplying circuit 209, which generates a component N of appropriate size. The circuit U 302 may be replaced by using a fixed value of “1” for the most significant bit RMX_{MSB}—however a drawback of this solution is that it will cause a decrease in the number of possible, different values of N that may be obtained.

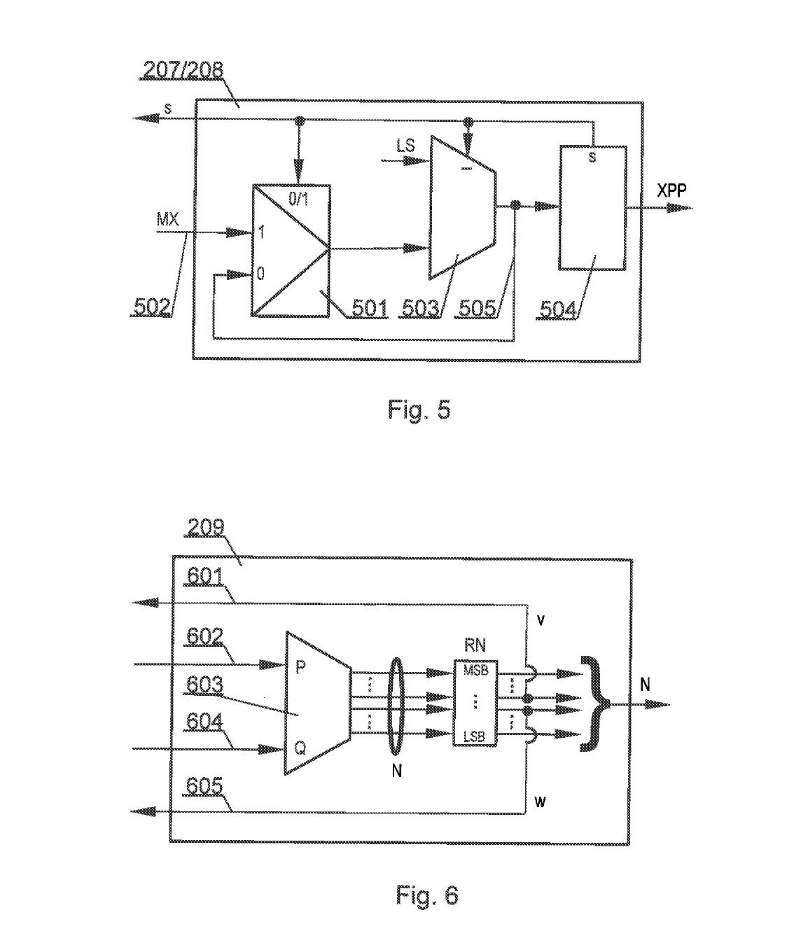

FIG. 5 shows a schematic example of a circuit for generating probable prime numbers (207, 208).

Preferably, the circuit for generating probable prime numbers 207, 208 comprises a primality control circuit 504, comprising an output s that may have a first logical state (e.g. “1”) indicating that the number XPP is probably a prime number and a second logical state (e.g. “0”) indicating the opposite. Further, the primality control circuit 504 outputs a probable prime number XPP. The primality control, implemented by the primality control circuit 504, may be achieved by application of the Miller-Rabin's probabilistic primality test, which is most efficient and can be implemented as hardware in a digital system. However, the primality control may be deterministic, for example by applying the sieve of Eratosthenes. Nevertheless, deterministic methods for checking the primality are disadvantageous, because they require a long execution time. In addition to the Miller-Rabin's method, there are known other effective, probabilistic methods for checking the primality of numbers, such as the Fermat's test or the Solovay-Strassen's test.

A multiplexer circuit 501 and an arithmetic circuit 503 are driven by the output s of the primality control circuit 504, in order to perform subtraction of a natural number LS from the current input value provided from the output of the arithmetic circuit 503 as a signal 505, by the multiplexer 501. The natural number LS must be different than “0”, because in such a case it would not lead to any progress in searching for a probable prime number. In order not to skip the probable prime numbers, the LS may be the smallest even integer that is greater than “0”, which also guarantees quick finding of a probable prime number. Nevertheless, the LS may also be another, even not necessarily constant, natural number. It may be a variable, such as 4, 6, 8, . . . , whereas it is preferable, due to the variety of generated values of probable prime numbers, that LS is different from “2”. In that case, the subsequent probable prime numbers will not be the closest numbers to P or Q plus/minus M, but different numbers. However, for the LS value different than “2”, the probable prime numbers could be skipped till infinity, which would increase the execution time. Taking the foregoing analysis into account, the preferred value of the number LS is “2”.

The aforementioned action of subtracting the value LS is executed until a probable prime number is found, which is signaled by a logical state “1” on the output s. This results in ending the subtraction and storing the new probable prime number in the registers 201, 202, according to FIG. 2.

FIG. 6 shows a schematic example of a multiplying circuit 209. This embodiment comprises a register RN storing the value of the number N. The number of bits of the number N may be arbitrary, however the most significant bit of N and the least significant bit of N should be equal to “1”. This results from the requirement of the size of N and keeping the N odd, wherein N is the product of two probable prime numbers, i.e. odd numbers. The output signals w 605 and v 606 of the multiplying circuit 209 are single bits. If, for example, N has a size of n=log₂ N equal to 128 bits, then the bit having number 64=n/2 constitutes the signal w 605, while the bit having number 65=n/2+1 constitutes the signal v 601.

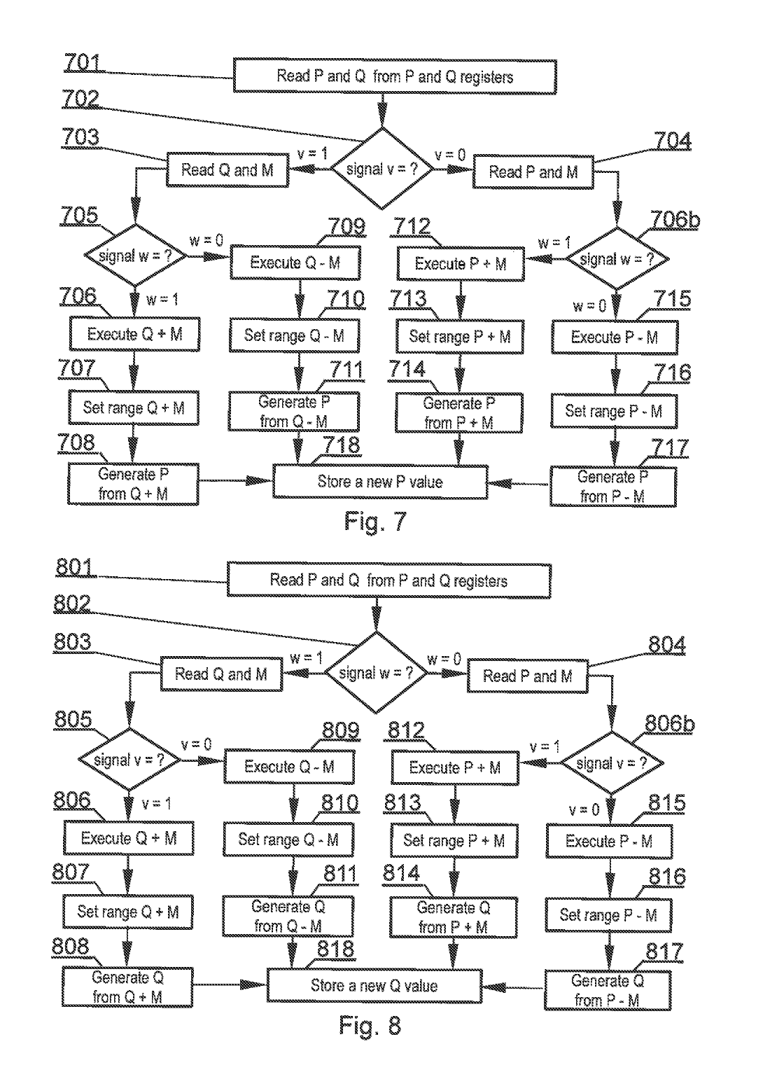

Preferably, the bits w and v of N, output as a component of a following one-time key from the multiplying circuit 209, via the multiplexers 203, 204 connected to the circuits for modification of input number values 205, 206 and via the circuits for generating probable prime numbers 207, 208, as shown in FIG. 2, implement a method shown as a block diagram in FIG. 7 and FIG. 8.

FIG. 7 shows a diagram indicating actions for determining and storing the probable prime number P.

The first step 701 of the process is reading the values P and Q from the first register 201 and the second register 202, respectively. Next, in step 702 the state of the signal v (i.e. the output of the multiplying circuit 209) is checked. In case the value of signal v is “1”, then the values of Q and M are read in step 703 and in step 705 the value of signal w (i.e. the output of the multiplying circuit 209) is checked. In case the value of the signal w is “1”, in step 706 the addition operation of Q+M is performed. The range of values Q+M is determined in step 707. The range is set in the circuit U 302 as shown in FIG. 3 by setting “1” in the RMX_{MSB}. Subsequently, in step 708, the P value is generated on the basis of the value of Q+M. In an opposite case, when the value of the signal w is “0”, there operation of Q−M is executed in step 709 and the values range Q−M is determined in step 710 in the circuit U 302, so that after subtracting M from Q the size of the result is not lower than the set size. Next, the P value is generated on the basis of Q−M in step 711.

In an opposite case, when the value of signal v is “0” the values of P and M are read in step 704 and in step 706b the value of signal w (i.e. the output of the multiplying circuit 209) is checked. in case the value of the signal w is “1”, the operation of P+M is executed in step 712 and a range of values P+M is set in step 713. The range is set in the circuit U 302. Subsequently, in step 714 the P value is generated on the basis of P+M. In an opposite case, when the value of the signal w is “0”, the operation of P−M is executed in step 715 and the range of values P−M is determined in step 716. The range is determined, as previously explained, in the circuit U 302. Next, the P value is generated on the basis of P−M in step 711.

The operations of Q+M, Q−M, P+M or P−M are realized by the circuit for modification of input number values 205. The generation of P on the basis of Q+M, Q−M, P+M or P−M is realized by the circuit for generating probable prime numbers 207.

After execution of one of the steps 708, 711, 714, 717, in step 718 the new value P is stored in the first register 201.

FIG. 8 shows a diagram indicating actions for determining and storing the probable prime number Q. This process matches the steps of the process shown in FIG. 7 with a difference in that in FIG. 8, the signal w is checked first in step 802 and subsequently the signal v is checked in steps 805, 806b. Further, a result of the process is generation in steps 808, 811, 814, 817 and storing in step 818 of a new value Q in the second register 202.

FIG. 9 shows a diagram of a method for generating one-time keys for encryption operations as well as a method for determining an encrypted message. This diagram depicts the aforementioned processes on a higher abstraction level by summarizing the method on a single diagram. The procedure starts in step 901 by reading the previously stored values P and Q, wherein P and Q are probable prime numbers. According to the circuit shown in FIG. 2, the stored P or Q values are read, depending on the states of the signals v and w, in order to generate the new values P and Q. Next, in step 902, the read values P and Q are modified by applying the modifier M and the additive operation as well as by adjusting their size. Subsequently, in step 903 new probable prime values P and Q are generated, based on the modified values P or Q, and they are stored in step 904. Next, in step 905 the generated values P and Q are multiplied and the values of the control signals w 605 and v 601 are determined. In step 906, the result N is stored and N is output as a newly generated component of a key {e, N}. Finally, in step 907, an encrypted message S 110 is determined as S=W^{e} modulo N, for a message W 104 and the encryption key {e, N}.

In another embodiment, the hardware circuits shown in FIG. 2 and further related figures depicting a hardware implementation, may be implemented by a software using appropriate software modules and variables and/or constants stored in a computer memory.

For the presented system, it is important that the generation of the number N is an irreversible process and guarantees generation of different values in subsequent steps, i.e. having values different than generated previously.

The process of data generation, for example encryption keys, is irreversible if deterministic data are transformed into forms, from which original data cannot be obtained, even by entities who have a complete knowledge regarding the data generation method. This means that even having the value N, which is a component of the encryption key, one cannot unambiguously determine what were the previous values N.

In the presented method for keys generation, the irreversibility is achieved by generating subsequent P and Q values as probable prime numbers, generated from the prior values P and modified by the value M. For example, 97+8=105 and a probable prime number lower than 105 is 103. A result of 103−8=95, which is different than 97. Therefore, if M is subtracted from a probable prime number XPP, which is generated based on P+M or Q+M, then the result will not be P nor Q.

In encryption systems based on the RSA algorithm, it is the modular exponentiation circuit that generates encrypted messages, implementing S=W^{e} modulo N. In one-time key encryption systems, the encryption keys change and information on how to change a key must be delivered to a trusted party that decrypts the message. By integrating a generator of one-time keys with an encrypting and decrypting device, the need to communicate data regarding the following key is eliminated, because they are embedded in the encrypting device.

As presented above, for each transaction that involves creation of an encrypted message, it is not necessary to transmit to the encryption circuit any additional information, which would be needed to configure it to a new value of an encryption key.

Moreover, the one-time key encryption system described herein comprises two communicating subsystems: an encryptor subsystem and a transaction server, and it does not need a transaction intermediary subsystem.

The presented system and method can be applied in cryptographic devices for encrypting data and authorizing users in computer and telecommunication systems. They guarantee different values of encryption keys and irreversibility of encryption keys. Thus, it provides a useful, concrete and tangible result.

The presented method and system process data readable by a computer and can be applied in a data encryptor, thus the machine or transformation test is fulfilled and that the idea is not abstract.

It can be easily recognized, by one skilled in the art, that the aforementioned method for generating one-time keys, for encryption operations, may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory while an example of a volatile memory is RAM. The computer instructions are executed by a processor. These memories are exemplary recording media for storing computer programs comprising computer-executable instructions performing all the steps of the computer-implemented method according the technical concept presented herein.

While the method and system presented herein are shown, described, and defined with reference to particular preferred embodiments, such references and examples of implementation in the foregoing specification do not imply any limitations. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

1. A computer-implemented method for irreversible generating of distinct one-time encryption keys, wherein for each subsequent operation of generating the one-time encryption key, the method comprises the following steps, performed with a one-time key generator:
reading previously stored values P and Q to obtain read values P and Q, wherein the values P and Q are probable prime numbers, wherein a new value P is generated by reading the value P or Q depending on a state of a signal v and wherein a new value Q is generated by reading the value P or Q depending on a state of a signal w, wherein the signals w and v are any two bits of a number N except the least and most significant bits of the number N, wherein N is a result of multiplication performed in a preceding operation of generating the one-time encryption key for the stored values P and Q;
modifying the read values P and Q by using a modifier M and an additive operation, including size adjustment to obtain modified values P and Q;
generating, based on the modified values P and Q, new values P and Q as probable prime numbers;
storing the new values P and Q as stored values P and Q;
executing a multiplication operation on the stored values P and Q to determine a new value N; and
providing the new value N as a new component of the one-time encryption key.

2. The computer-implemented method according to claim 1, wherein the output new value N forms a component of the one-time encryption key {e, N}, the method further comprising determining an encrypted message S=W^{e} modulo N for a message W and for the one-time encryption key {e, N}, wherein e is a coprime integer from φ(N).

3. A circuit for generating one-time encryption keys, the circuit comprising:
a first register having:
a first input P for receiving a value P,
a second input s for receiving a control signal s,
the first register being configured to store the value P in response to the control signal s and to provide the value P at its output;
a second register having:
a first input Q for receiving a value Q,
a second input s for receiving a control signal s,
the second register being configured to store the value Q in response to the control signal s and to provide the value Q at its output;
a first multiplexer having:
a first input connected to the output of the second register,
a second input connected to the output of the first register,
and a third input connected to an output v of a multiplying circuit,
the first multiplexer being configured to provide at its output the value Q or P depending on the state of a signal v at its third input;
a second multiplexer having:
a first input connected to the output of the first register,
a second input connected to the output of the second register,
and a third input connected to an output w of a multiplying circuit,
the second multiplexer being configured to provide at its output the value P or Q depending on the state of a signal w at its third input;
a first circuit for modification of input number values, having:
a first input X for receiving a number value and connected to the output of the first multiplexer,
a second input M for receiving a modifier value M,
a third input k for receiving the signal w and connected to the output w of the multiplying circuit,
the first circuit for modification of input number values being configured to modify the number value provided at the first input X on the basis of the modifier value M and the state of the signal w and to provide at its output a modified number value;
a second circuit for modification of input number values, having:
a first input X for receiving a number value and connected to the output of the second multiplexer,
a second input M for receiving the modifier value M,
a third input k for receiving the signal v and connected to the output v of the multiplying circuit,
the second circuit for modification of input number values being configured to modify the number value provided at the first input X on the basis of the modifier value M and the state of the signal v and to provide at its output a modified number value;
a first circuit for generating probable prime numbers, having:
a input MX for receiving an input number and connected to the output of the first circuit for modification of input number values,
a first output XPP for outputting a probable prime number and connected to the first input P of the first register and to the first input P of the multiplying circuit,
a second output s, for outputting an indication whether the number provided at the first output XPP is probably prime, the second output s being connected to the second input s of first register;
a second circuit for generating probable prime numbers, having:
a input MX for receiving an input number and connected to the output of the second circuit for modification of input number values,
a first output XPP for outputting a probable prime number and connected to the first input Q of the second register and to the second input Q of the multiplying circuit,
a second output s, for outputting an indication whether the number provided at the first output XPP is probably prime, the second output s being connected to the second input s of second register;
a multiplying circuit having:
a first input P connected for receiving a number P and connected to the first output XPP of the first circuit for generating probable prime numbers,
a second input Q for receiving a number Q and connected to the first output XPP of the second circuit for generating probable prime numbers,
the multiplying circuit being configured to:
provide at its first output N an n-bit product N, wherein N=P*Q;
provide at its second output v any bit of the product N except for the least and most significant bits of the product N, wherein the second output v is connected to the third input of the first multiplexer;
provide at its third output w any bit of the product N except for the least and most significant bits of the product N, wherein the second output w is connected to the third input of the second multiplexer;
wherein the product N is a component of the one-time encryption key.

4. The circuit according to claim 3, wherein the modifier value M changes in time and is a power of 2 such that M=2^{z}, wherein an exponent z changes according to the size of a message W to be encrypted with the one-time encryption key {e, N}.

5. The circuit according to claim 3, wherein each of the first circuit for generating probable prime numbers and the second circuit for generating probable prime numbers comprises a primality control circuit, the primality control circuit comprising an output s configured to provide the control signal s indicating by a logical state “1” that the number output at the output XPP is probable prime and to indicate by a logical state “0” that the number output at the output XPP is not probable prime.

6. The circuit according to claim 4, wherein each of the first circuit for generating probable prime numbers and the second circuit for generating probable prime numbers comprises a primality control circuit, the primality control circuit comprising an output s configured to provide the control signal s indicating by a logical state “1” that the number output at the output XPP is probable prime and to indicate by a logical state “0” that the number output at the output XPP is not probable prime.

7. An encryption system comprising:
a circuit for generating one-time encryption keys, the circuit comprising:
a first register having:
a first input P for receiving a value P,
a second input s for receiving a control signal s,
the first register being configured to store the value P in response to the control signal s and to provide the value P at its output;
a second register having:
a first input Q for receiving a value Q,
a second input s for receiving a control signal s,
the second register being configured to store the value Q in response to the control signal s and to provide the value Q at its output;
first multiplexer having:
a first input connected to the output of the second register,
a second input connected to the output of the first register,
and a third input connected to an output v of a multiplying circuit,
the first multiplexer being configured to provide at its output the value Q or P depending on the state of a signal v at its third input;
a second multiplexer having:
a first input connected to the output of the first register,
a second input connected to the output of the second register,
and a third input connected to an output w of a multiplying circuit,
the second multiplexer being configured to provide at its output the value P or Q depending on the state of a signal w at its third input;
a first circuit for modification of input number values, having:
a first input X for receiving a number value and connected to the output of the first multiplexer,
a second input M for receiving a modifier value M,
a third input k for receiving the signal w and connected to the output w of the multiplying circuit,
the first circuit for modification of input number values being configured to modify the number value provided at the first input X on the basis of the modifier value M and the state of the signal w and to provide at its output a modified number value;
a second circuit for modification of input number values, having:
a first input X for receiving a number value and connected to the output of the second multiplexer,
a second input M for receiving the modifier value M,
a third input k for receiving the signal v and connected to the output v of the multiplying circuit,
the second circuit for modification of input number values being configured to modify the number value provided at the first input X on the basis of the modifier value M and the state of the signal v and to provide at its output a modified number value;
a first circuit for generating probable prime numbers, having:
a input MX for receiving an input number and connected to the output of the first circuit for modification of input number values,
a first output XPP for outputting a probable prime number and connected to the first input P of the first register and to the first input P of the multiplying circuit,
a second output s, for outputting an indication whether the number provided at the first output XPP is probably prime, the second output s being connected to the second input s of first register;
a second circuit for generating probable prime numbers, having:
a input MX for receiving an input number and connected to the output of the second circuit for modification of input number values,
a first output XPP for outputting a probable prime number and connected to the first input Q of the second register and to the second input Q of the multiplying circuit,
a second output s, for outputting an indication whether the number provided at the first output XPP is probably prime, the second output s being connected to the second input s of second register;
a multiplying circuit having:
a first input P connected for receiving a number P and connected to the first output XPP of the first circuit for generating probable prime numbers,
a second input Q for receiving a number Q and connected to the first output XPP of the second circuit for generating probable prime numbers,
the multiplying circuit being configured to:
provide at its first output N an n-bit product N, wherein N=P*Q;
provide at its second output v any bit of the product N except for the least and most significant bits of the product N, wherein the second output v is connected to the third input of the first multiplexer;
provide at its third output w any bit of the product N except for the least and most significant bits of the product N, wherein the second output w is connected to the third input of the second multiplexer;
wherein the product N is a component of the one-time encryption key;
a modular exponentiation circuit having:
a first input connected to the first output N of the multiplying circuit of the circuit for generating one-time encryption keys;
a second input connected to an output of an input circuit;
a third input for receiving a natural number e being a component of the one-time encryption key {e, N};
the modular exponentiation circuit being configured to provide at its output an encrypted message S;
wherein the input circuit is configured to adjust, transform and synchronize an input signal W to the second input of the modular exponentiation circuit, wherein the second input of the modular exponentiation circuit is a multi-position binary input having a size of log₂ N.

8. The encryption system according to claim 7, wherein the modifier value M changes in time and is a power of 2 such that M=2^{z}, wherein an exponent z changes according to the size of a message W to be encrypted with the one-time encryption key {e, N}.

9. The encryption system according to claim 7, wherein each of the first circuit for generating probable prime numbers and the second circuit for generating probable prime numbers comprises a primality control circuit, the primality control circuit comprising an output s configured to provide the control signal s indicating by a logical state “1” that the number output at the output XPP is probable prime and to indicate by a logical state “0” that the number output at the output XPP is not probable prime.

10. The encryption system according to claim 8, wherein each of the first circuit for generating probable prime numbers and the second circuit for generating probable prime numbers comprises a primality control circuit, the primality control circuit comprising an output s configured to provide the control signal s indicating by a logical state “1” that the number output at the output XPP is probable prime and to indicate by a logical state “0” that the number output at the output XPP is not probable prime.
